(19) United States
(12) Patent Application Publication
(10) Pub. No.: US 2013/0162342 A1
(43) Pub. Date: Jun. 27, 2013

(54) REFERENCE VOLTAGE GENERATOR OF SEMICONDUCTOR INTEGRATED CIRCUIT

(71) Applicant: Choung-Ki SONG, Gyeonggi-do (KR)

(72) Inventor: Choung-Ki SONG, Gyeonggi-do (KR)

(21) Appl. No.: 13/404,576

(22) Filed: Feb. 24, 2012

(30) Foreign Application Priority Data
Dec. 21, 2011 (KR) 10-2011-0139634

(51) Int. Cl. G05F 3/02

(52) U.S. Cl. 327/543

(57) ABSTRACT

A reference voltage generation circuit for a semiconductor integrated circuit includes a first reference voltage generation unit configured to generate a reference voltage in mode other than a self-refresh mode, and a second reference voltage generation unit configured to additionally drive an output terminal of the first reference voltage generation unit in an initial reference voltage setting period.

### CROSS-REFERENCE TO RELATED APPLICATIONS

The present application claims priority of Korean Patent Application No. 10-2011-0139634, filed on Dec. 21, 2011, which is incorporated herein by reference in its entirety.

### BACKGROUND

1. Field

Exemplary embodiments of the present invention relate to a semiconductor integrated circuit designing technology, and more particularly, to a reference voltage generation circuit of a semiconductor integrated circuit.

2. Description of the Related Art

A semiconductor integrated circuit receives a power source voltage VDD and a ground voltage VSS from a circuit outside of the semiconductor integrated circuit, and the semiconductor integrated circuit generates and uses a number of different internal voltages having different voltage levels by making use of the received power source voltage VDD and ground voltage VSS.

Also, a semiconductor integrated circuit uses a reference voltage VREF to receive signals such as command signals, clock signals, data signals, and address signals from circuits outside of the semiconductor integrated circuit. The semiconductor integrated circuit may receive and use the reference voltage VREF from device circuit outside of the semiconductor integrated circuit, but as mentioned before, the semiconductor integrated circuit may also generate and use the reference voltage VREF within the semiconductor integrated circuit. For example, a memory device, such as a Dynamic Random Access Memory (DRAM) device, may internally generate and use a reference voltage VREFDQ of an input buffer for receiving a data signal DQ.

FIG. 1 is a circuit diagram of a reference voltage VREFDQ generation circuit of a conventional semiconductor integrated circuit.

Referring to FIG. 1, the reference voltage VREFDQ generation circuit of the conventional semiconductor integrated circuit includes a resistor row and a plurality of transmission gates. The resistor row includes a plurality of resistors that are serially coupled between a power source voltage VDD and a ground voltage VSS. The transmission gates select any one among a plurality of output signals from the resistor row and output a reference voltage VREFDQ in response to a corresponding control code among a plurality of control codes CODE000T, CODE000B, . . . , CODE111T, and CODE111B.

The control code among the multiple control codes CODE000T, CODE000B, . . . , CODE111T, and CODE111B is determined by a Mode Set Register (MRS). In other words, the mode set register outputs a voltage of a designated level as the reference voltage VREFDQ. The control codes CODE000T and CODE000B are in an inverse relationship.

The reference voltage VREFDQ has to maintain a designated voltage level throughout a memory access operation of the semiconductor integrated circuit. Of course, the reference voltage

VREFDQ does not have to operate in an operation mode where power is restrictively supplied, such as a self-refresh mode.

Furthermore, a capacitance Cstatic of the reference voltage VREFDQ terminal is to have a relatively great capacitance to have less of a reaction against a coupling capacitance that is generated from interference between internal lines. Moreover, since the reference voltage VREFDQ is used in the input buffer, a great capacitance value is used to be less affected by the influence of various parasitic capacitances.

Additionally, since a current Istatic of the resistor row is a factor for power consumption, the value of the current Istatic is to be relatively small.

If the capacitance Cstatic of the reference voltage VREFDQ terminal is great and the current Istatic of the resistor row is small, the setting time of the reference voltage VREFDQ is increased. More specifically, the time taken for setting the reference voltage VREFDQ of a designated voltage is increased during an initial operation of the reference voltage generation circuit. For example, when the reference voltage generation circuit is turned off in a self-refresh mode and subsequently is turned back on, setting the reference voltage VREFDQ again takes a relatively long time. Therefore, the reference voltage generation circuit is not turned off even in the self-refresh mode when the reference voltage generation circuit does not have to operate.

When the current Istatic of the resistor row is set to a higher current level, the time for setting the reference voltage VREFDQ may become shorter. However, power consumption is increased due to the increase in the current Istatic of the resistor row.

As described above, the power consumption and the reference voltage setting time are in a trade-off relationship in the reference voltage generation circuit of the conventional semiconductor integrated circuit.

### SUMMARY

An embodiment of the present invention is directed to a reference voltage generation circuit of a semiconductor integrated circuit that may shorten an initial setting time of a reference voltage while suppressing an increase in power consumption.

In accordance with an embodiment of the present invention, a reference voltage generation circuit for a semiconductor integrated circuit includes: a first reference voltage generation unit configured to generate a reference voltage in mode other than a self-refresh mode; and a second reference voltage generation unit configured to additionally drive an output terminal of the first reference voltage generation unit in an initial reference voltage setting period.

In accordance with another embodiment of the present invention, a reference voltage generation circuit of a semiconductor integrated circuit includes: a first division unit configured to generate a plurality of first divided voltages in a mode other than a self-refresh mode; a first selection unit configured to select any one first divided voltage among the plurality of first divided voltages and output a selected first divided voltage as a reference voltage in response to a control code; a second division unit configured to generate a plurality of second divided voltages in an initial reference voltage setting period; and a second selection unit configured to select any one second divided voltage among the plurality of second divided voltages and output a selected second divided voltage as the reference voltage in response to the control code.

### BRIEF DESCRIPTION OF THE DRAWINGS

FIG. 1 is a circuit diagram of a reference voltage VREFDQ generation circuit of a conventional semiconductor integrated circuit.

FIG. 2 is a block diagram of a reference voltage VREFDQ generation circuit of a semiconductor integrated circuit in accordance with an embodiment of the present invention.

FIG. 3 is a block diagram of a reference voltage VREFDQ generation circuit of a semiconductor integrated circuit in accordance with another embodiment of the present invention.

FIG. 4 is a circuit diagram of the reference voltage VREFDQ generation circuit shown in FIG. 3.

FIG. 5 is a circuit diagram illustrating a pulse generation unit for generating a boost control signal BSTER.

FIG. 6 is a timing diagram illustrating the waveforms of a boost control signal BSTER and a self-refresh signal SREFB.

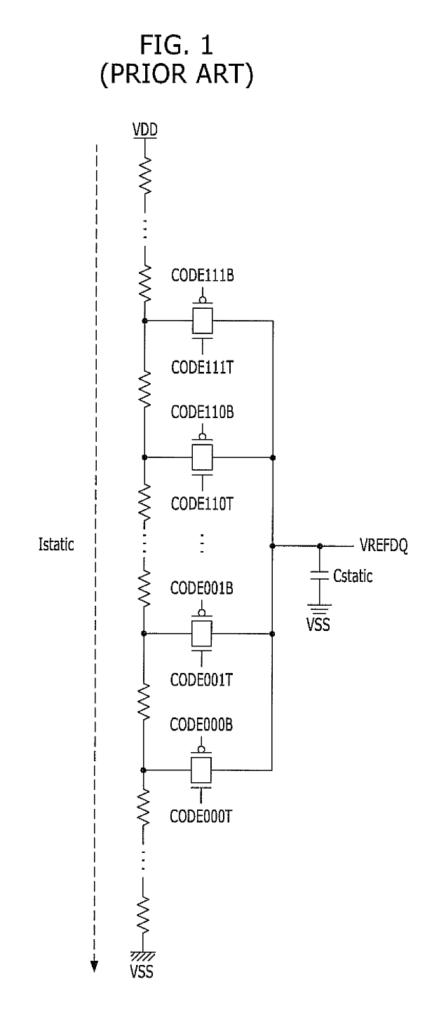

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

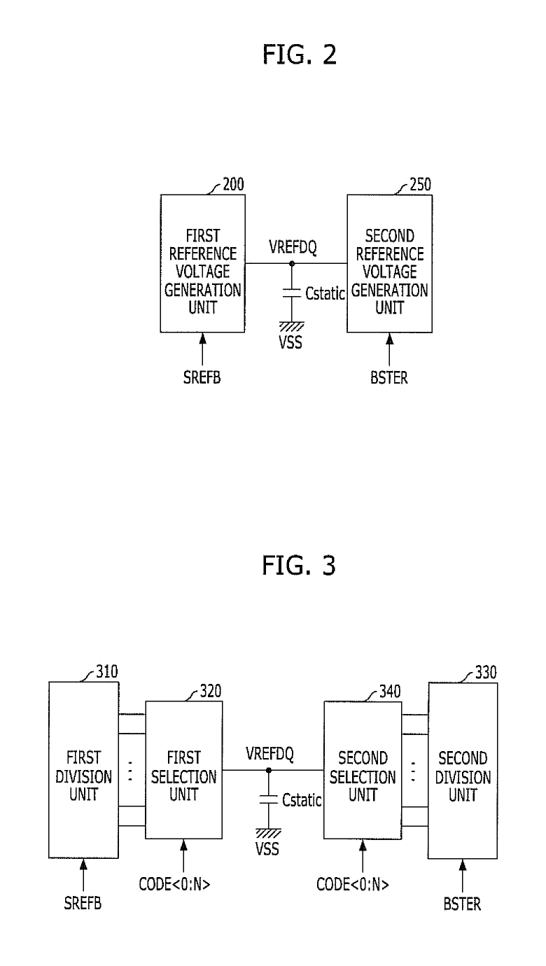

FIG. 2 is a block diagram of a reference voltage VREFDQ generation circuit of a semiconductor integrated circuit in accordance with an embodiment of the present invention.

Referring to FIG. 2, the reference voltage VREFDQ generation circuit of the semiconductor integrated circuit in accordance with the embodiment of the present invention includes a first reference voltage generation unit 200 and a second reference voltage generation unit 250. The first reference voltage generation unit 200 generates a reference voltage VREFDQ in a mode other than a self-refresh mode, for example, a normal mode. The second reference voltage generation unit 250 additionally drives an output terminal of the first reference voltage generation unit 200 in the initial reference voltage setting period for setting the reference voltage VREFDQ.

Furthermore, a self-refresh signal SREFB may be used to define the self-refresh mode and the mode other than the self-refresh mode, and a boost control signal BSTER, which is activated for a period of time from a reference voltage setting point in time, may be used to define the reference voltage setting period.

Also, the first reference voltage generation unit 200 and the second reference voltage generation unit 250 generate reference voltages of substantially the same voltage levels.

Since the self-refresh signal SREFB is not activated in the self-refresh mode, and when the boost control signal BSTER is in an disabled state, the first reference voltage generation unit 200 and the second reference voltage generation unit 250 are all disabled and do not generate any reference voltage VREFDQ in the self-refresh mode.

In addition, when the reference voltage generation circuit ends the self-refresh mode, the self-refresh signal SREFB and the boost control signal BSTER are both activated for the initial reference voltage setting period. Therefore, in the initial reference voltage setting period, both of the first reference voltage generation unit 200 and the second reference voltage generation unit 250 are activated and generate the reference voltage VREFDQ. As described, since both of the first reference voltage generation unit 200 and the second reference voltage generation unit 250 drive a reference voltage VREFDQ terminal together, the time for setting the reference voltage VREFDQ may be decreased by half. Also, the reference voltage generation circuit does not have to increase the current for each of the first reference voltage generation unit 200 and the second reference voltage generation unit 250. Moreover, the reference voltage generation circuit may be turned off in an operation period where the reference voltage VREFDQ is not to be generated, such as a self-refresh mode. Therefore, power consumption may be decreased when compared to the conventional reference voltage generation circuit.

Subsequently, when the reference voltage VREFDQ reaches the designated voltage level and the boost control signal BSTER is disabled, the second reference voltage generation unit 250 is turned off and, for example, only the first reference voltage generation unit 200 drives the reference voltage VREFDQ terminal.

FIG. 3 is a block diagram of a reference voltage VREFDQ generation circuit of a semiconductor integrated circuit in accordance with another embodiment of the present invention.

Referring to FIG. 3, the reference voltage generation circuit of the semiconductor integrated circuit in accordance with the second embodiment of the present invention includes a first division unit 310, a first selection unit 320, a second division unit 330, and a second selection unit 340. The first division unit 310 generates a plurality of first divided voltages in a mode other than a self-refresh mode. The first selection unit 320 selects any one among the multiple first divided voltages and outputs a reference voltage VREFDQ in response to a control code CODE<0:N>. The second division unit 330 generates a plurality of second divided voltages in an initial reference voltage setting period. The second selection unit 340 selects any one among the multiple second divided voltages and outputs a reference voltage VREFDQ in response to the control code CODE<0:N>.

Furthermore, a self-refresh signal SREFB may be used to define the self-refresh mode and the mode other than a self-refresh mode, and a boost control signal BSTER, which is activated for a period of time from a reference voltage setting point, in time may be used to define the initial reference voltage setting period.

The control code CODE<0:N> may be set in a mode register set (MRS).

Also, the first selection unit 320 and the second selection unit 340 output a reference voltage of substantially the same voltage level.

Since the self-refresh signal SREFB is not activated in the self-refresh mode, and the boost control signal BSTER is in a disabled state, both of the first division unit 310 and the second division unit 330 are disabled and do not output any divided voltage in the self-refresh mode.

In addition, when the reference voltage generation circuit ends the self-refresh mode, the self-refresh signal SREFB and the boost control signal BSTER are activated for the initial reference voltage setting period. Therefore, both of the first division unit 310 and the second division unit 330 are activated and individually output divided voltages. The first selection unit 320 and the second selection unit 340 select any one divided voltage among the multiple first divided voltages and the multiple second first divided voltages, respectively, and output the selected divided voltage to the reference voltage VREFDQ terminal. One first divided voltage and one second divided voltage that correspond to any one activated control code among the control codes CODE<0:N> are outputted to the reference voltage VREFDQ terminal.

Since the reference voltage VREFDQ terminal is driven with the selected first divided voltage and the selected second divided voltage at the same time, the time taken for setting the reference voltage VREFDQ may be decreased by half. Also, the reference voltage generation circuit does not have to increase the current in each of the first division unit 310 and the second division unit 330. Moreover, since the reference voltage generation circuit may be turned off in an operation duration when the reference voltage VREFDQ is not to be generated, such as a self-refresh mode, current consumption may be reduced when compared to the conventional reference voltage generation circuit.

Subsequently, when the reference voltage VREFDQ reaches the designated voltage level and the boost control signal BSTER is disabled, the second division unit 330 is turned off, and the reference voltage VREFDQ terminal is driven, for example, only with the voltages generated in the first division unit 310 and the first selection unit 320.

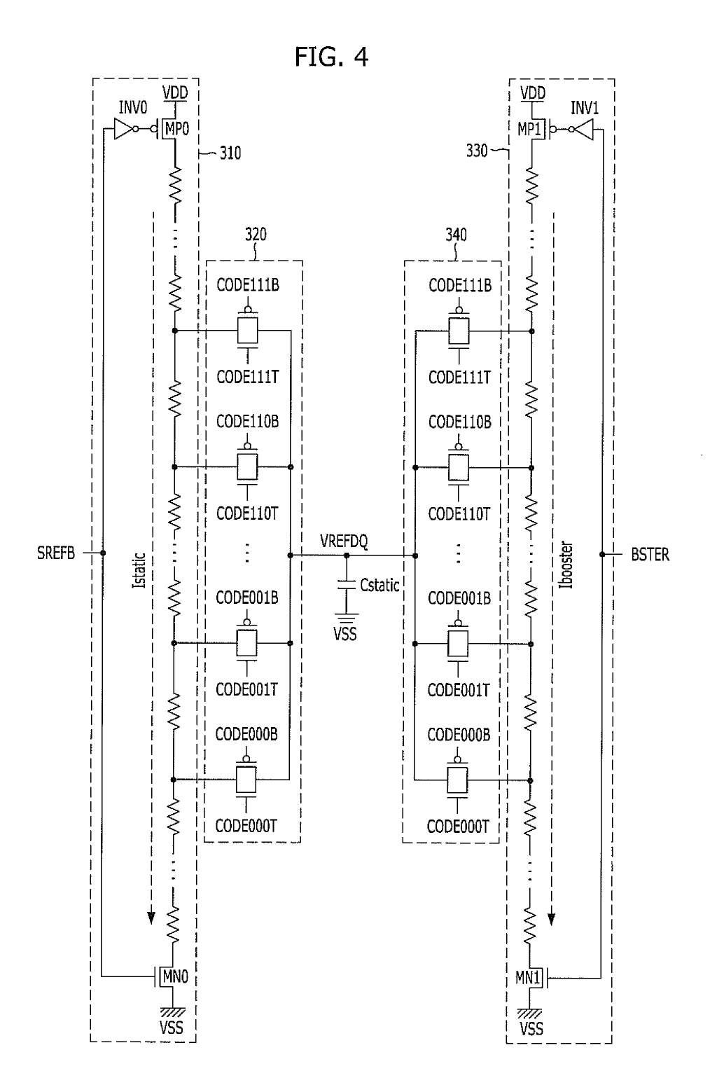

FIG. 4 is a circuit diagram of the reference voltage VREFDQ generation circuit shown in FIG. 3.

Referring to FIG. 4, the first division unit 310 includes an inverter INV0, a PMOS transistor MP0, an NMOS transistor MN0, and a plurality of resistors. The inverter INV0 receives a self-refresh signal SREFB. The PMOS transistor MP0 includes a source coupled with a power source voltage VDD terminal and a gate that receives an output signal of the inverter INV0. The NMOS transistor MN0 includes a source coupled with a ground voltage VSS terminal and a gate that receives the self-refresh signal SREFB. The resistors are serially connected between a drain of the PMOS transistor MP0 and a drain of the NMOS transistor MN0.

Similarly, the second division unit 330 includes an inverter INV1, a PMOS transistor MP1, an NMOS transistor MN1, and a plurality of resistors. The inverter INV1 receives a boost control signal BSTER. The PMOS transistor MP1 includes a source coupled with a power source voltage VDD terminal and a gate that receives an output signal of the inverter INV1. The NMOS transistor MN1 includes a source coupled with a ground voltage VSS terminal and a gate that receives the boost control signal BSTER. The resistors are serially connected between a drain of the PMOS transistor MP1 and a drain of the NMOS transistor MN1. The resistance values and arrangements of the resistors that constitute the first division unit 310 and the second division unit 330 are substantially the same.

Also, the first selection unit 320 includes a plurality of transmission gates that select any one divided voltage among a plurality of first divided voltages of the first division unit 310 and output a reference voltage VREFDQ in response to a corresponding control code among a plurality of controls codes control codes CODE000T, CODE000B, . . . , CODE111T, and CODE111B. The values of the control codes CODE000T, CODE000B, . . . , CODE111T, and CODE111B may be set in a mode register set (MRS). The control code CODE000T and the control code CODE000B are in an inverse relationship.

Similarly, the second selection unit 340 includes a plurality of transmission gates that select any one divided voltage among a plurality of second divided voltages of the second division unit 330 and output a reference voltage VREFDQ in response to a corresponding control code among a plurality of controls codes control codes CODE000T, CODE000B, . . . , CODE111T, and CODE111B.

Additionally, the reference voltage generation circuit includes a capacitance Cstatic of the reference voltage VREFDQ terminal.

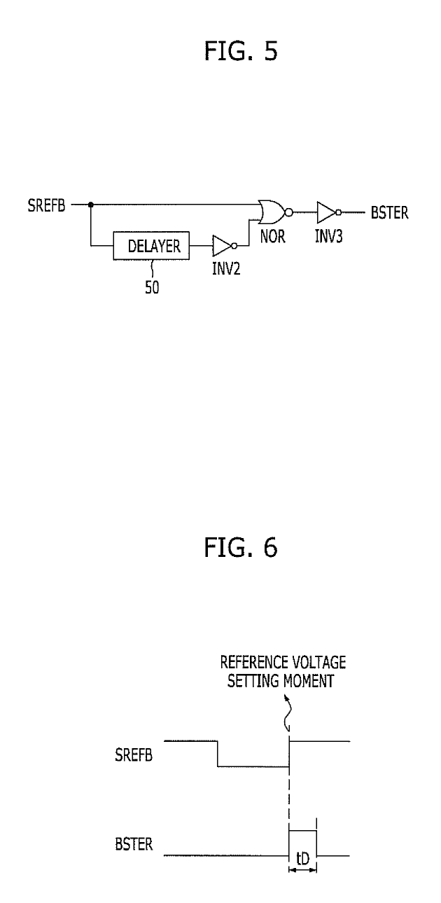

FIG. 5 is a circuit diagram illustrating a pulse generation unit for generating the boost control signal BSTER.

Referring to FIG. 5, the pulse generation unit includes a delayer 50, an inverter INV2, a NOR gate NOR, and an inverter INV3. The delayer 50 delays a self-refresh signal SREFB by a delay time tD and outputs a delayed signal. The inverter INV2 receives the delayed signal of the delayer 50. The NOR gate NOR receives the output signal of the inverter INV2 and the self-refresh signal SREFB. The inverter INV3 receives the output signal of the NOR gate NOR and outputs a boost control signal BSTER.

FIG. 6 is a timing diagram illustrating the waveforms of the boost control signal BSTER and the self-refresh signal SREFB. The operation of the reference voltage generation circuit shown in FIG. 4 is described in reference to the timing diagram.

First, the self-refresh signal SREFB is an inverted signal of a self-refresh signal SREF. The self-refresh signal SREFB maintains a logic low level in a self-refresh mode and transitions to a logic high level in a mode other than the self-refresh mode.

Since the self-refresh signal SREFB is in a logic low level in the self-refresh mode, and when the boost control signal is in a logic low level, all the transistors of the first division unit 310 and the second division unit 330 are turned off and no current Istatic and Ibooster flow through the resistor rows of the first division unit 310 and the second division unit 330. In the self-refresh mode, the first division unit 310 and the second division unit 330 do not output a first divided voltage and a second divided voltage.

In addition, when the reference voltage generation circuit ends the self-refresh mode, the self-refresh signal SREFB and the boost control signal BSTER transition to a logic high level for the initial reference voltage setting period. Therefore, all the transistors of the first division unit 310 and the second division unit 330 are turned on and thus, currents Istatic and Ibooster flow through the resistor rows of the first division unit 310 and the second division unit 330 and corresponding divided voltages are outputted. The first selection unit 320 and the second selection unit 340 select any one first divided voltage and any one second divided voltage among the multiple first divided voltages and the multiple second divided voltages, respectively, and output the selected divided voltages to the reference voltage VREFDQ terminal. More specifically, one first divided voltage and one second divided voltage corresponding to any one control code among the control codes CODE000T, CODE000B, . . . , CODE111T, and CODE111B are outputted to the reference voltage VREFDQ terminal.

As described above, since the reference voltage VREFDQ terminal is driven with the selected first divided voltage and the selected second divided voltage at the same time, time taken for setting the reference voltage VREFDQ may be reduced by half. Also, the reference voltage generation circuit does not have to increase the current consumed in the resistor rows of the first division unit 310 and the second division unit 330. Moreover, since the reference voltage generation circuit may be turned off in an operation mode where the reference voltage VREFDQ is not to be generated, such as a self-refresh mode, current consumption may be reduced when compared to the conventional reference voltage generation circuit.

Subsequently, when the reference voltage VREFDQ is set and the boost control signal BSTER transitions to a logic low level, the NMOS transistor MN1 and the PMOS transistor MP1 of the second division unit 330 are turned off, and the NMOS transistor MN0 and the PMOS transistor MP0 of the first division unit 310 remain turned on. Therefore, the reference voltage VREFDQ terminal is driven, for example, only with the voltage generated in the first division unit 310 and the first selection unit 320.

According to an embodiment of the present invention, the initial setting time of a reference voltage generation circuit may be shortened while minimizing power consumption.

While the present invention has been described with respect to the specific embodiments, it will be apparent to those skilled in the art that various changes and modifications may be made without departing from the spirit and scope of the invention as defined in the following claims.

For example, the logic circuits illustrated in the above-described embodiments may be replaced with other logic circuits or omitted according to the type of a signal and the activation level of the signal.

Also, although the above embodiment illustrates a reference voltage generation circuit that generates a reference voltage VREFDQ of a data input buffer, the reference voltage generation circuit in accordance with an embodiment of the present invention may be applied to the generation of another reference voltage.

In addition, although the above embodiment describes a self-refresh signal being used to define a normal mode as an example, the self-refresh signal may not be used.

What is claimed is:

1. A reference voltage generation circuit for a semiconductor integrated circuit, comprising:
a first reference voltage generation unit configured to generate a reference voltage in mode other than a self-refresh mode; and
a second reference voltage generation unit configured to additionally drive an output terminal of the first reference voltage generation unit in an initial reference voltage setting period.

2. The reference voltage generation circuit of claim 1, wherein the first reference voltage generation unit is configured to be activated in response to a self-refresh signal.

3. The reference voltage generation circuit of claim 1, wherein the second reference voltage generation unit is configured to be activated in response to a boost control signal that is activated for the initial reference voltage setting period.

4. The reference voltage generation circuit of claim 1, wherein the initial reference voltage setting period begins at a point in time when the reference voltage generation circuit ends the self-refresh mode.

5. The reference voltage generation circuit of claim 1, wherein the second reference voltage generation unit is configured to generate a reference voltage of substantially the same voltage level as the reference voltage generated in the first reference voltage generation unit.

6. The reference voltage generation circuit of claim 1, wherein the reference voltage is a reference voltage of a data input buffer.

7. A reference voltage generation circuit of a semiconductor integrated circuit, comprising:
a first division unit configured to generate a plurality of first divided voltages in a mode other than a self-refresh mode;
a first selection unit configured to select any one first divided voltage among the plurality of first divided voltages and output a selected first divided voltage as a reference voltage in response to a control code;
a second division unit configured to generate a plurality of second divided voltages in an initial reference voltage setting period; and
a second selection unit configured to select any one second divided voltage among the plurality of second divided voltages and output a selected second divided voltage as the reference voltage in response to the control code.

8. The reference voltage generation circuit of claim 7, wherein the first division unit is activated in response to a self-refresh signal.

9. The reference voltage generation circuit of claim 8, wherein the second division unit is configured to be activated in response to a boost control signal that is activated for the initial reference voltage setting period.

10. The reference voltage generation circuit of claim 7, wherein the initial reference voltage setting period begins at a point in time when the reference voltage generation circuit ends the self-refresh mode.

11. The reference voltage generation circuit of claim 9, wherein the first division unit comprises:
a first inverter configured to receive the self-refresh signal;
a first PMOS transistor including a source coupled with a power source voltage terminal and a gate configured to receive an output signal of the first inverter;
a first NMOS transistor including a source coupled with a ground voltage terminal and a gate configured to receive the self-refresh signal; and
a plurality of first resistors serially connected between a drain of the first PMOS transistor and a drain of the first NMOS transistor to form a first resistor row.

12. The reference voltage generation circuit of claim 11, wherein the second division unit comprises:
a second inverter configured to receive the boost control signal;
a second PMOS transistor including a source coupled with a power source voltage terminal and a gate configured to receive an output signal of the second inverter;
a second NMOS transistor including a source coupled with a ground voltage terminal and a gate configured to receive the boost control signal; and
a plurality of second resistors serially connected between a drain of the second PMOS transistor and a drain of the second NMOS transistor to form a second resistor row.

13. The reference voltage generation circuit of claim 12, wherein an arrangement the first resistor row and an arrangement of the second resistor row are substantially the same.

14. The reference voltage generation circuit of claim 9, further comprises a pulse generation unit configured to generate the boost control signal using the self-refresh signal.

15. The reference voltage generation circuit of claim 14, wherein the pulse generation unit includes:
a delayer configured to delay the self-refresh signal by a first delay time;
a first inverter configured to receive an output signal of the delayer;
a NOR gate configured to receive an output signal of the first inverter and the self-refresh signal; and
a second inverter configured to receive an output signal of the NOR gate and output the boost control signal.

16. The reference voltage generation circuit of claim 7, wherein the selected first divided voltage outputted from the first selection unit is substantially the same voltage level of the selected second divided voltage outputted from the second selection unit.

17. The reference voltage generation circuit of claim 7, wherein the first selection unit includes:
a plurality of transmission gates configured to select any one first divided voltage among the plurality of first divided voltages and output the selected first divided voltage as the reference voltage in response to a corresponding control code.

18. The reference voltage generation circuit of claim 7, wherein the second selection unit includes:
a plurality of transmission gates configured to select any one second divided voltage among the plurality of second divided voltages and output the selected second divided voltage as the reference voltage in response to the corresponding control code.

19. The reference voltage generation circuit of claim 7, wherein the reference voltage is a reference voltage of a data input buffer.
